(19) United States
(12) Patent Application Publication
(10) Pub. No.: US 2016/0327988 A1
(43) Pub. Date: Nov. 10, 2016

(54) A DISPLAY DEVICE FOR AN ELECTRONIC DEVICE

(71) Applicant: CREATIVISION (I.P) LTD., Kidron (IL)

(72) Inventors: YARIV ERAD, KIDRON (IL); MENACHEM ERAD, ASHDOD (IL)

(21) Appl. No.: 15/037,722

(22) PCT Filed: Nov. 19, 2014
(86) PCT No.: PCT/IL2014/051007

§ 371 Date: May 19, 2016

Related U.S. Application Data
(60) Provisional application No. 61/906,538, filed on Nov. 20, 2013.

(51) Int. Cl. G06F 1/16; G06F 3/01

(52) U.S. Cl. CPC G06F 1/1656; G06F 1/1647; G06F 3/017

(57) ABSTRACT

The subject matter discloses a mobile electronic device, comprising a display device and a physical mechanism for changing a size of the display device. The device also comprises a processor for controlling a change of the size of the display device. The display device may be formed of a single sheet of material, or assembled of two or more electronically coupled sub-screens and have a maneuver element for enabling maneuver of at least one of the two or more electronically coupled sub-screens.

### FIELD OF THE INVENTION

The invention generally relates to a display device connected to an electronic device.

### BACKGROUND OF THE INVENTION

There is a growing proliferation of mobile devices, such as smartphone, tablets, phablets, laptops, ultra-light laptops, digital cameras and the like. One of the new devices to enter the market is the smartwatch. Current smartwatches are, in most cases, small electronic devices, with a touch-screen, capable to wirelessly communicate with a larger mobile device or with remote servers. In some cases, the smartwatches offer limited control over the other mobile device, and in other cases, smartwatches offer a way to present data received from the mobile device.

Due to the limited screen size that a smartwatch can have, its display is by nature limited. Thus, it cannot offer the same full functionality as smartphones or tablets offer. There are conceptual designs that offer devices made from a full flexible material, which can be flattened to be used as a flat display, when not around the user's wrist. US patent application published under serial number US20130044215, by Apple Inc. describes such wearable device, in which the device can be flexed into bracelet around the user's hand. Samsung and Motorola are also known to be working on flexible displays that can be worn as bracelets. Yet, there is still room for other types of devices, which can offer a different way to enable greater functionality in a smartphone-like device.

### SUMMARY OF THE INVENTION

It is an object of the subject matter to disclose a mobile electronic device, comprising a display device, a physical mechanism for changing a size of the display device and a processor for controlling a change of the size of the display device.

In some cases, the display device is assembled of two or more electronically coupled sub-screens and the device comprises a maneuver element for enabling maneuver of at least one of the two or more electronically coupled sub-screens.

In some cases, at least one sub-screen of the two or more electronically coupled sub-screens is removable from the display device. In some cases, a first sub-screen of the two or more electronically coupled sub-screens is foldable from a second sub-screen of the two or more electronically coupled sub-screens. In some cases, a first sub-screen of the two or more electronically coupled sub-screens is located below a second sub-screen of the two or more electronically coupled sub-screens and slid by the maneuver element to be located in the surface of the a second sub-screen of the two or more electronically coupled sub-screens.

In some cases, the mobile electronic device further comprises a sensor unit for sensing when a user of the mobile electronic device watches the display device and the processor instructs the maneuver element to maneuver a sub-screen of the two or more electronically coupled sub-screens to enlarge the display device.

In some cases, the processor instructs the maneuver element to maneuver a sub-screen of the two or more electronically coupled sub-screens according to information displayed on the main display device. In some cases, the property of the information displayed on the display device changes according to a property of the size of the display device.

In some cases, the processor instructs the maneuver element to maneuver a sub-screen of the two or more electronically coupled sub-screens according to information displayed on a second electronic device wirelessly communicating with the mobile electronic device. In some cases, the processor instructs the maneuver element to maneuver a sub-screen of the two or more electronically coupled sub-screens according to a signal sent between the mobile electronic device and a second electronic device wirelessly communicating with the mobile electronic device.

In some cases, the mobile electronic device further comprises a user interface connected to the processor, wherein a sub-screen of the two or more electronically coupled sub-screens is automatically maneuvered responsive to detection of a predefined gesture performed on the user interface.

In some cases, a sub-screen of the two or more electronically coupled sub-screens is transparent. In some cases, at least one sub-screen of the two or more electronically coupled sub-screens is activated responsive to being maneuvered by the maneuver element.

In some cases, at least one sub-screen of the two or more electronically coupled sub-screens is activated responsive to its location relative to another sub-screen of the two or more electronically coupled sub-screens.

In some cases, at least one sub-screen of the two or more electronically coupled sub-screens is made of an elastic material. In some cases, at least two sub-screens of the two or more electronically coupled sub-screens are of different shapes. In some cases, one sub-screen of the two or more electronically coupled sub-screens is configured to slide onto another sub-screen of the two or more electronically coupled sub-screens.

In some cases, a sub-screen of the two or more electronically coupled sub-screens comprises an independent processor. In some cases, a sub-screen of the two or more electronically coupled sub-screens comprises a wireless transceiver. In some cases, the maneuver element maneuvers the secondary display device to be aligned to the main display device.

In some cases, the maneuver element maneuvers a first sub-screen of the two or more electronically coupled sub-screens to form a slope between a display surface of the first sub-screen and a display surface of a second sub-screen of the two or more electronically coupled sub-screens.

In some cases, the maneuver element maneuvers a first sub-screen of the two or more electronically coupled sub-screens such that a display surface of the first sub-screen is parallel to a display surface of the second sub-screen of the two or more electronically coupled sub-screens and located on different axes.

In some cases, the position of a first sub-screen of the two or more electronically coupled sub-screens relative to a second sub-screen of the two or more electronically coupled sub-screens is determined according to the content displayed on a sub-screen of the two or more electronically coupled sub-screens.

In some cases, the maneuvering element is configured to change the location of a first sub-screen of the two or more electronically coupled sub-screens relative to a second sub-screen of the two or more electronically coupled sub-screens while maintaining the size of the display device.

In some cases, two or more sub-screen of the two or more electronically coupled sub-screens move synchronously according to commands from the processor. In some cases, a shape of the display device is variable.

In some cases, the mobile electronic device further comprises a ring-like element connected to the circumference of the display device, wherein the size of the display device changes responsive to rotation of the ring-like element around the display device.

In some cases, the display device is formed of a single sheet of material. In some cases, the single sheet of material changes its size upon injection of voltage into a component of the mobile electronic device. In some cases, the single sheet of material changes its size upon change in temperature of a component of the mobile electronic device.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 shows a display device of an electronic device capable of changing its size, in accordance with a preferred embodiment of the invention;

FIG. 2 shows a display device having a changeable size using sub-screens on the same surface, according to exemplary embodiments of the subject matter;

FIG. 3A shows a side view of a display device having a changeable size using sub-screens positioned on different layers, according to exemplary embodiments of the subject matter;

FIG. 3B shows a top view of a display device having a changeable size using sub-screens positioned on different layers, according to exemplary embodiments of the subject matter;

FIG. 4 shows two sub-screens of the display device, one sliding on top of the other, according to exemplary embodiments of the subject matter;

FIG. 5 shows electronic communication between two sub-screens of the display device, according to exemplary embodiments of the disclosed subject matter; and,

FIG. 6 shows electronic components of an electronic device having a display device with changeable screen size, according to exemplary embodiments of the disclosed subject matter.

### DETAILED DESCRIPTION OF THE INVENTION

The present invention discloses a mobile electronic device with a display device capable of changing its size. The size of the display device may vary in case the display device is made of an elastic material, at least partially. The elastic material may be manually stretched by the user, or automatically according to an electro-mechanical process, for example by heating a portion of the elastic sheet. In some other cases, the display device is made of a single sheet of material, as a portion of the sheet is flapped under the rest of the sheet. In some other cases, the display device comprises two or more sub-screens movable by a maneuver element, such that movement of at least one of the two or more sub-screens changes the total area of the display device.

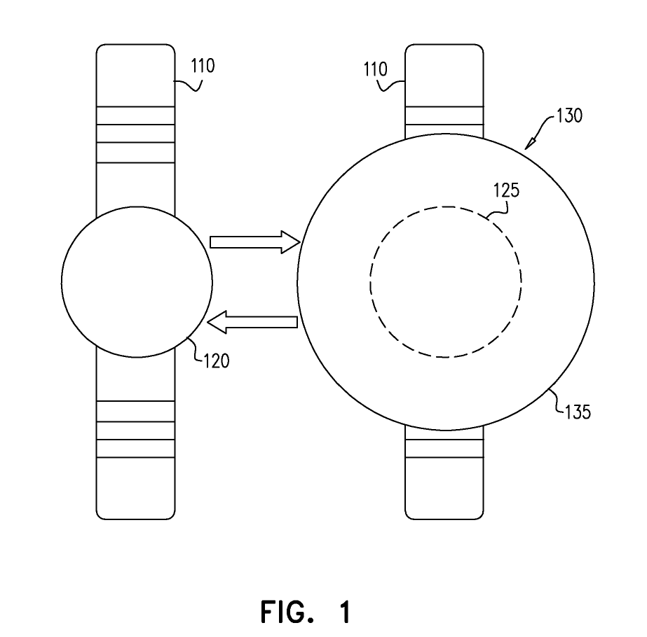

FIG. 1 shows a display device of an electronic device capable of changing its size, in accordance with a preferred embodiment of the invention. The display device 120 is connected to a wrist 110 to form a smartwatch. The display device of the present invention can be used in any mobile electronic device such as a tablet, smartphone, smart glasses and the like. The size of the first configuration of the display device 120 changes and is enlarged to form a second configuration of the display device 130 made of the same sheet of material used to form the first configuration of the first configuration of the display device 120, without the need for additional sub-screens or additional material. Changing the size of the single sheet of material may be implemented in a specific material that can change its size as a result of change in a physical or chemical conditions or actions. Such physical or chemical actions may be heating or cooling at least a portion of the sheet of material forming the first configuration of the display device 120, or injecting voltage of a predefined amount into the sheet of material. Other actions may be used by a person skilled in the art. It can be seen that the size 135 of the second configuration of the second configuration of the display device 130 is larger than the size 125 of the first configuration of the display device 120.

The change in the size of the display device may be performed responsive to an event such as the information type displayed on the display device. For example, in case the display device shows a video file, the display device is enlarged and when ten (10) minutes pass without the user operating the electronic device, the size of the display device is reduced in a predefined manner. The size of the display device may change according to a command received from a user of the electronic device. Such command may be inputted by the user via an input unit, or vocally via a microphone.

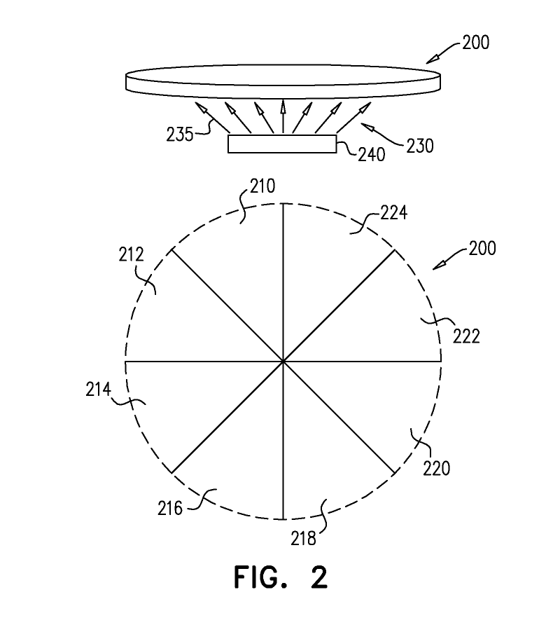

FIG. 2 shows a display device having a changeable size using sub-screens on the same surface, according to exemplary embodiments of the subject matter. When spanned to the maximal size, the display device 200 is circular and comprises 8 sub-screens—210, 212, 214, 216, 218, 220, 222 and 224. In some other cases, the display device comprises 4 sub-screens, or any other number of two or more sub-screens that are movable using a maneuver element connected to an electronic device, such as a smartphone, that uses the display device 200. The maneuver element comprises a base 240 connected to the electronic device, and a plurality of arms such as arms 230, 235 connecting the base 240 to the sub-screens. The arms 230, 235 are configured to move the sub-screens to a position determined by a processor of the electronic device, when changing the total size of the display device. The arms 230, 235 may also change their lengths, for example as being implemented as a telescopic arm. In some exemplary cases, each sub-screen is associated with a single arm. In some other cases, two or more sub-screens are maneuvered by a single arm.

When the size of the display device 200 is reduced, the arms 230, 235 maneuver at least a portion of the sub-screens to be placed under other sub-screens. For example, sub-screen 210 is positioned under sub-screen 218, sub-screen 212 is positioned under sub-screen 220, sub-screen 214 is positioned under sub-screen 222 and sub-screen 216 is positioned under sub-screen 224. In such a case, the shape of the display device 200 may also change when the size is reduced.

In accordance with some exemplary embodiments of the subject matter, the display surface of the 8 sub-screens is unified, defined as being of the same height. At least some of the 8 sub-screens are electronically coupled, as information and voltage can pass between a first sub-screen 210 and a second sub-screen 212. In some other cases, a sub-screen may be activated only when positioned by the arms in the surface of other sub-screens. In some other cases, a portion of the sub-screens are defined as default display units, which display information in all sizes of the display device, while other sub-screens are considered as optional display units, defined as showing information only in some sizes of the display device.

In some exemplary cases, a sub-screen of the two or more sub-screens that assemble the display device is activated only upon a predefined event, condition or command from a user of the electronic device to which the display device is attached. For example, sub-screen 210 only operate when moved by its respective arm, or when the display device shows a video file. In some other cases, one or more sub-screens of the display device are maneuvered by the maneuvering element according to the events disclosed above, or any other event or condition desired by a person skilled in the art. Such events may be the position of a first sub-screen relative to a second sub-screen. That is, the first sub-screen will display information only when the display surface of the first sub-screen is not aligned to the display surface of the second sub-screen.

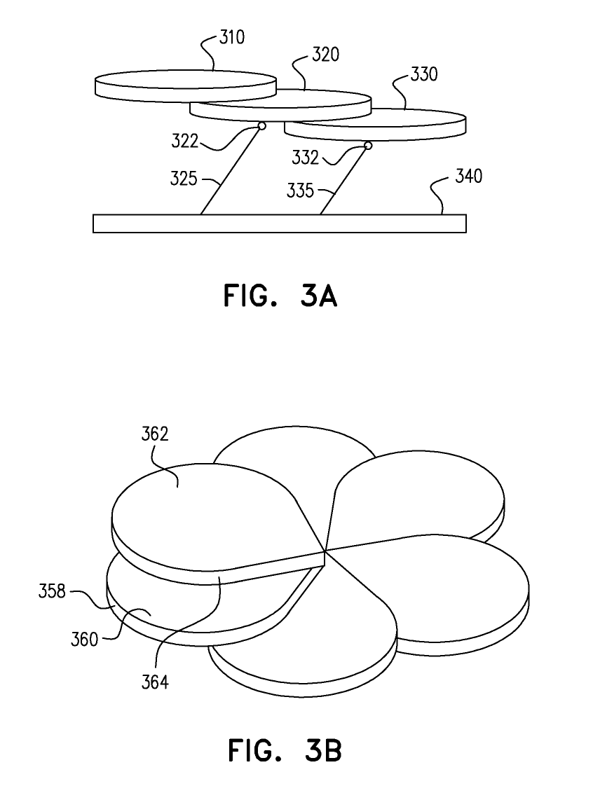

FIG. 3A shows a side view of a display device having a changeable size using sub-screens positioned on different layers, according to exemplary embodiments of the subject matter. When positioned on different layers, one sub-screen 310 may be defined as a top sub-screen, as other sub-screens can be slid under the top sub-screen. For example, sub-screen 320 can slide under top sub-screen 310 via a mechanical arm 325. The mechanical arm 325 may contact the sub-screen 320 in a contact point 322 that may be implemented as a hinge, to facilitate the movement of the mechanical arm 325 in various angles from a base 340 while sliding the sub-screen 320 under the top sub-screen 310. Similarly, sub-screen 330 can slide under top sub-screen 320 using mechanical arm 335 connected to the sub-screen 330 on contact point 332. The mechanical arms 325, 335 are connected to a power source and receive commands from a processor. The processor may reside on the base 340 or on the electronic device that contains the display device of the present invention.

FIG. 3B shows a top view of a display device having a changeable size using sub-screens positioned on different layers, according to exemplary embodiments of the subject matter. A display surface 362 of a first sub-screen is positioned on a layer higher than a layer of a display surface 360 of a second sub-screen. The lateral surface 364 of the first sub-screen does not overlap with the lateral surface 358 of the second sub-screen in order to allow the second sub-screen to be positioned under the second sub-screen.

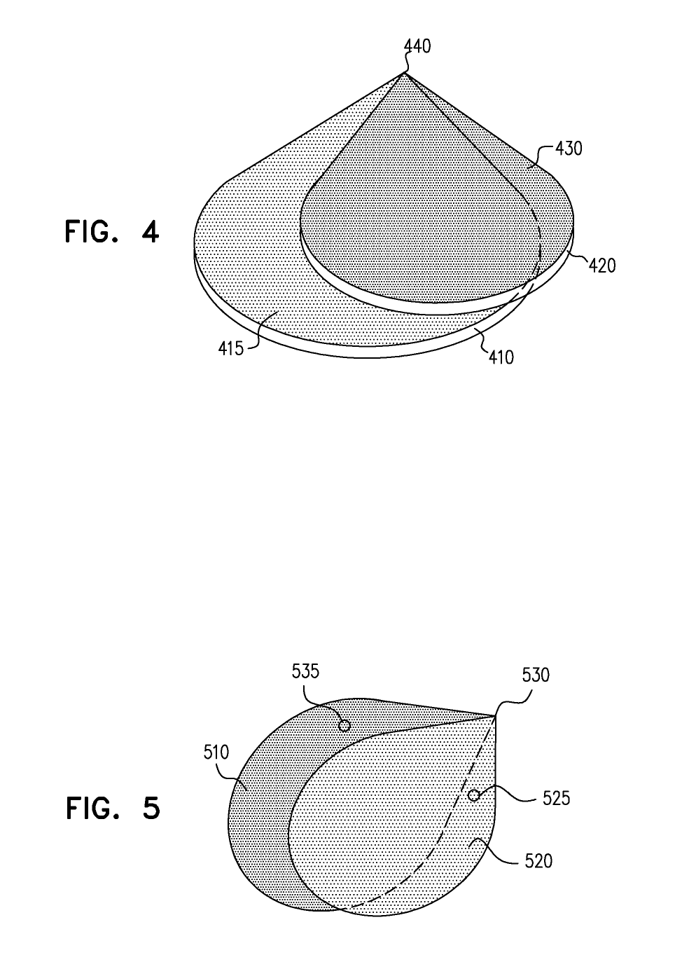

FIG. 4 shows two sub-screens of the display device, one sliding on top of the other, according to exemplary embodiments of the subject matter. A first sub-screen of the display device is defined as having an upper surface 415, also referred to as a display surface, as the upper surface 415 is configured to display information to the user of the electronic device. The lateral surface 410 of the first sub-screen is of another height than the lateral surface 420 of the second sub-screen of the display device. Additionally, the lateral surfaces 420 and 410 do not overlap, which enables the upper surface 430 of the second sub-screen to be positioned under the bottom surface (not shown) of the first sub-screen. Sliding the second sub-screen may be performed using a mechanical arm disclosed above, or for example via a motor embedded in the second sub-screen. In some other cases, the location of the second sub-screen is constant, and the higher sub-screen, the first sub-screen, is slid on top of the upper surface 430 of the second sub-screen.

FIG. 5 shows electronic communication between two sub-screens of the display device, according to exemplary embodiments of the disclosed subject matter. A first sub-screen 510 is connected to a second sub-screen 520 via a contact point 530. The contact point 530 is configured to transmit information from a first electronic circuitry 535 of the first sub-screen 510 to a second electronic circuitry 525 of the second sub-screen 520. In some exemplary cases, the first electronic circuitry 535 and the second electronic circuitry 525 comprises a processor for determining information displayed on a sub-screen of the respective electronic circuitry. The processors may be used to identify actions made on the respective sub-screens, such as movement of the sub-screens 520, 510. The processors may be used to command the maneuver element of the respective sub-screen to maneuver the sub-screen responsive to a command inputted into a touch screen implemented on the sub-screens.

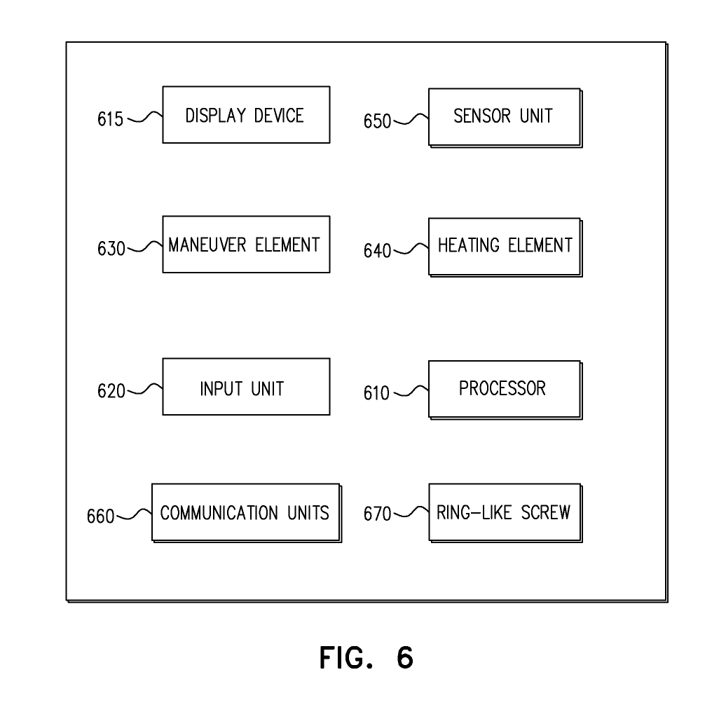

FIG. 6 shows electronic components of an electronic device having a display device with changeable screen size, according to exemplary embodiments of the disclosed subject matter.

The electronic device comprises a processor 610 configured to control the operations of the electronic device. For example, the processor may determine the size of the display device 615, decide which information is displayed on the display device 615, which electronic component to activate, and how. The processor 610 may transmit commands to other components of the electronic device, such as maneuvering element 630, in case there is a need to move a sub-screen of the display device 615. The processor 610 may send a command to the heating element 640 in case there is a need to heat or cool a component in the display device 615 in order to change the size of the display device 615, when the display device 615 is made of a single sheet of material.

The electronic device comprises a display device 615 configured to display information. The information displayed on the display device 615 may be received from another device wirelessly communicating with the electronic device, such as a server, a tablet, a smartphone or a personal computer. The display device 615 is able to change its size, either automatically or by the user of the electronic device. Change of size of the display device 615 may be performed in response to a predefined event, such as time of the day, type of information displayed on the display device and the like. Change of size of the display device 615 may be performed in response to a command from another device, or a command from a user of the electronic device. The display device 615 may be made of a single sheet of material. In such a case, when desired to change its size, the single sheet may be stretched or spanned in response to a chemical or physical reaction, such as injecting a material or voltage or changing a temperature of a component inside the single sheet of material. In other cases, a portion of the single sheet of material may flap under another portion of the same sheet of material, to reduce the size of the display device, according to a command from the processor.

In some other cases, the display device 615 is made of two or more sub-screens, electronically coupled. A portion of the information displayed on the display device 615 is displayed on one sub-screen and another portion of the information is displayed on another sub-screen. The sub-screens are maneuvered by a maneuver mechanism 630, for example a plurality of arms connected to the electronic device on one end and to the sub-screens on another end. In some cases, activation of a sub-screen of the display device 615 is made in response to a predefined event, such as change of the location or position of the sub-screen, or in response to a command from the processor 610.

The electronic device may also comprise an input unit 620 that enables a user of the device to input commands or information into the electronic device. The input unit 620 may be implemented as a touch screen on the display device 615. The user's input may be received at the input unit via a microphone. The input unit 620 may be used to change the size of the display device 615, responsive to the user's commands or information. For example, the user can touch a predefined area of the input unit 620 to input a command concerning the size of the display device 615.

The electronic device may also comprise a maneuver element 630 to maneuver one or more elements of the display device 615 when changing the size of the display device 615. In some cases, the maneuver element 630 is used to move sub-screens of the display device 615, in case the display device 615 is made of two or more sub-screens. The maneuver element 630 may comprise arms connected on one end to the electronic device and on another end to the sub-screens, for example via hinges. The maneuver element 630 may be used to slide one sub-screen on top of the other, or under the other. The maneuver element 630 may maneuver a sub-screen in a manner that maintains the orientation of the sub-screen, for example keeps all the display surfaces of the sub-screens parallel.

The electronic device may also comprise a heating element 640 for heating or cooling a component of the electronic device. In some exemplary cases, the size of the display device 615 changes in response to heating or cooling a component of the electronic device, for example a sheet located inside the display device 615 which changes its shape or size responsive to change in temperature.

The electronic device may also comprise a sensor unit 650 for sensing information associated with the display device. The sensor unit 650 may comprise a camera, a microphone, image processing unit and the like. The sensor unit 650 may detect when a user of the mobile electronic device watches the display device 615. In such a case, the processor 610 may instruct the maneuver element 630 to maneuver a sub-screen of the two or more electronically coupled sub-screens to enlarge the display device 615.

The electronic device may also comprise communication units 660 within sub-screens. The communication units 660 are configured to independently transfer information between sub-screens, without the need to use the processor 610, to enhance the functionality of the display device 615, when the display device 615 is made of two or more sub-screens as detailed above.

The electronic device may also comprise a Ring-like screw 670 connected to the display device 615 or to the maneuver element 630. When the user of the electronic device moves the Ring-like screw 670 rotationally, the size of the display device 615 changes, in accordance to any of the assemblies disclosed above, such as injecting heat, voltage, moving a sub-screen and the like.

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

1. A mobile electronic device, comprising:
a display device;
a physical mechanism for changing a size of the display device;
a processor for controlling a change of the size of the display device.

2. The mobile electronic device of claim 1, wherein the display device is assembled of two or more electronically coupled sub-screens;
a maneuver element for enabling maneuver of at least one of the two or more electronically coupled sub-screens.

3. The mobile electronic device of claim 2, wherein at least one sub-screen of the two or more electronically coupled sub-screens is removable from the display device.

4. The mobile electronic device of claim 2, wherein a first sub-screen of the two or more electronically coupled sub-screens is foldable from a second sub-screen of the two or more electronically coupled sub-screens.

5. The mobile electronic device of claim 2, wherein a first sub-screen of the two or more electronically coupled sub-screens is located below a second sub-screen of the two or more electronically coupled sub-screens and slid by the maneuver element to be located in the surface of the a second sub-screen of the two or more electronically coupled sub-screens.

6. The mobile electronic device of claim 2, further comprises a sensor unit for sensing when a user of the mobile electronic device watches the display device and the processor instructs the maneuver element to maneuver a sub-screen of the two or more electronically coupled sub-screens to enlarge the display device.

7. The mobile electronic device of claim 2, wherein the processor instructs the maneuver element to maneuver a sub-screen of the two or more electronically coupled sub-screens according to information displayed on the main display device.

8. The mobile electronic device of claim 7, wherein a property of the information displayed on the display device changes according to a property of the size of the display device.

9. The mobile electronic device of claim 2, wherein the processor instructs the maneuver element to maneuver a sub-screen of the two or more electronically coupled sub-screens according to information displayed on a second electronic device wirelessly communicating with the mobile electronic device.

10. The mobile electronic device of claim 2, wherein the processor instructs the maneuver element to maneuver a sub-screen of the two or more electronically coupled sub-screens according to a signal sent between the mobile electronic device and a second electronic device wirelessly communicating with the mobile electronic device.

11. The mobile electronic device of claim 2, further comprises a user interface connected to the processor, wherein a sub-screen of the two or more electronically coupled sub-screens is automatically maneuvered responsive to detection of a predefined gesture performed on the user interface.

12. The mobile electronic device of claim 2, wherein a sub-screen of the two or more electronically coupled sub-screens is transparent.

13. The mobile electronic device of claim 2, wherein at least one sub-screen of the two or more electronically coupled sub-screens is activated responsive to being maneuvered by the maneuver element.

14. The mobile electronic device of claim 2, wherein at least one sub-screen of the two or more electronically coupled sub-screens is activated responsive to its location relative to another sub-screen of the two or more electronically coupled sub-screens.

15. The mobile electronic device of claim 2, wherein at least one sub-screen of the two or more electronically coupled sub-screens is made of an elastic material.

16. The mobile electronic device of claim 2, wherein at least two sub-screens of the two or more electronically coupled sub-screens are of different shapes.

17. The mobile electronic device of claim 2, wherein one sub-screen of the two or more electronically coupled sub-screens is configured to slide onto another sub-screen of the two or more electronically coupled sub-screens.

18. The mobile electronic device of claim 2, wherein a sub-screen of the two or more electronically coupled sub-screens comprises an independent processor.

19. The mobile electronic device of claim 2, wherein a sub-screen of the two or more electronically coupled sub-screens comprises a wireless transceiver.

20. The mobile electronic device of claim 2, wherein the maneuver element maneuvers the secondary display device to be aligned to the main display device.

21. The mobile electronic device of claim 2, wherein the maneuver element maneuvers a first sub-screen of the two or more electronically coupled sub-screens to form a slope between a display surface of the first sub-screen and a display surface of a second sub-screen of the two or more electronically coupled sub-screens.

22. The mobile electronic device of claim 2, wherein the maneuver element maneuvers a first sub-screen of the two or more electronically coupled sub-screens such that a display surface of the first sub-screen is parallel to a display surface of the second sub-screen of the two or more electronically coupled sub-screens and located on different axes.

23. The mobile electronic device of claim 2, wherein the position of a first sub-screen of the two or more electronically coupled sub-screens relative to a second sub-screen of the two or more electronically coupled sub-screens is determined according to the content displayed on a sub-screen of the two or more electronically coupled sub-screens.

24. The mobile electronic device of claim 2, wherein the maneuvering element is configured to change the location of a first sub-screen of the two or more electronically coupled sub-screens relative to a second sub-screen of the two or more electronically coupled sub-screens while maintaining the size of the display device.

25. The mobile electronic device of claim 2, wherein two or more sub-screen of the two or more electronically coupled sub-screens move synchronously according to commands from the processor.

26. The mobile electronic device of claim 1, further comprises a ring-like element connected to the circumference of the display device, wherein the size of the display device changes responsive to rotation of the ring-like element around the display device.

27. The mobile electronic device of claim 1, wherein a shape of the display device is variable.

28. The mobile electronic device of claim 1, wherein the display device is formed of a single sheet of material.

29. The mobile electronic device of claim 28, wherein the single sheet of material changes its size upon injection of voltage into a component of the mobile electronic device using the physical mechanism.

30. The mobile electronic device of claim 28, wherein the single sheet of material changes its size upon change in temperature of a component of the mobile electronic device using the physical mechanism.
